(19) United States
(12) Patent Application Publication
(10) Pub. No.: US 2009/0028988 A1
(43) Pub. Date: Jan. 29, 2009

(54) Injection-Moulding Apparatus with Needle Valve Nozzle

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/224,380

(22) PCT Filed: Nov. 30, 2006
(86) PCT No.: PCT/EP2006/011494

§ 371 Date: Aug. 26, 2008

(30) Foreign Application Priority Data
Feb. 27, 2006 (DE) 202006003244.4

(51) Int. Cl. B29C 45/00

(52) U.S. Cl. 425/564

(57) ABSTRACT

An injection molding apparatus (1) comprising a manifold plate (3) is fitted with at least one flow duct (4) which has at least one needle valve nozzle for a flowable processing material to feed said material through an extension of said duct to a separable mold insert. A valve needle (20) fitted with a guide bush (30) to pass and seal the said needle—which by means of a drive can be moved into an open or a closed position—runs at least partly through the flow duct (4) in longitudinally displaceable manner. To further improve the guidance and sealing of the valve needle (20), the invention provides that within the guide bush (30) said needle shall be enclosed in geometrically interlocking manner within the guide bush (30) by an elastic, temperature-resistant plastic annulus (60).

The present invention relates to an injection molding apparatus fitted with needle valve nozzles as defined in the preamble of claim 1.

Needle valve nozzles are used in injection molding apparatus to feed a flowable processing material at a given temperature and high pressure to a separable mold insert. Most apparatus are fitted with pneumatically or hydraulically driven needles which periodically open and close sprue apertures in the mold insert. This design allows extremely accurate metering in particular at high operational injection rates. However a flowable processing material also may be injected in segments, for instance in cascade injection.

Each valve needle is axially displaceably supported on the mold-side of the injection apparatus and preferably moves centrally at the nozzle side through a processing material flow duct (see for instance DE 32 49 486 C3 or DE 34 03 603 A1). The flow duct terminates in a nozzle outlet which at its end constitutes a nozzle discharge aperture. In the closed position, the lower end of the valve needle engages a sealing seat constituted in the nozzle outlet or in the mold insert.

To tightly guide the valve needle, a guide bush or a sealing sleeve is typically inserted into the manifold plate of the injection molding apparatus, said bush or sleeve receiving the cylindrical shank of the valve needle (see for instance DE 39 26 357 A1 or EP 1 223 020 B1). An approximately free cylindrical space is subtended between the valve needle and the bush and is entered during operation of the injection molding apparatus by the flowable processing material, as a result of which the needle is sealed relative to the flow duct. At the same time a lubrication effect takes place, which reduces the friction between the valve needle and the bush.

Despite the optimal sealing design, the comparatively high pressures within the mold and the needle excursions make it inevitable that the processing material leaks out of the guide or sealing bush. Consequently processing material losses are incurred. Moreover the processing material residues soil both the valve needle and the mold, degrading not only sealing but also in the long run possibly hampering the valve needle's opening and closing motions. Complex and costly cleaning or maintenance are inevitable.

The objective of the present invention is to preclude the above and further drawbacks of the state of the art and to further improve the guidance and sealing of valve needles in an injection molding apparatus. A particular goal of the present invention is a sealing system which can be manufactured economically and offers easy handling.

The main features of the present invention are defined in claim 1. Embodiments of the present invention are defined in claims 2 through 22.

As regards an injection molding apparatus which comprises a manifold plate fitted with at least one flowable processing material flow duct, which further comprises at least one valve needle nozzle feeding the flowable processing material, while extending the flow duct, to a separable mold insert, which comprises at least one valve needle that traverses the flow duct at least in segments while being longitudinally displaceable and positioned by a drive into an open and a closed position, and which further comprises a guide bush to pass and seal the valve needle, the present invention provides that an annulus be provided within the guide bush and enclose the valve needle in geometrically locking manner. Not only is said valve needle guided radially, but it is also sealed, as a result of which hardly any processing material may still leak out of the bush.

Said annulus is fitted with an inside cylindrical surface coaxial with the valve needle, thereby implementing an exceedingly effective guidance and surface to surface seal. Appropriately too, the annulus shall be configured perpendicularly to the valve needle's longitudinal axis be configured in a tight fit within and to the bush. Further advantages are attained by making the annulus of an elastic steel or of a resilient, high temperature resistant plastic. In this manner the said needle shall always be very accurately supported in the annulus and at the same shall be very effectively sealed.

The bush preferably shall be in two parts to allow installing the annulus in it, these two halves being firmly affixed to each other for instance by welding, bonding or compression. At least one part shall receive the annulus: this feature advantageously affects handling during installation.

Alternatively at least two annuli may be used within the bush, as a result of which sealing is enhanced further.

Another significant embodiment of the present invention provides that the guide bush comprise two zones which are axially spaced from the annulus and are fitted with cylindrical inner surfaces coaxial with the valve needle and preferably constitute guide bush end zones. In this manner the valve needle within the bush shall rest at least on three points. Said needle shall always be very accurately guided and kept in a central position. Deflections from the central position are effectively precluded. The annulus, the end zones and the free space subtend a central, continuous needle valve borehole. Also the annulus and the end zones enclose the valve needle with a minimum of displacement play, and reliable, permanent sealing is attained.

A free space is subtended between the bush's end zones and subtends an inside diameter slightly larger than the outside diameter of the valve needle. Said free space allows the processing material to enter in controlled manner the bush wherein it assures lubrication to guide and slide the valve needle. Friction in the guide bush is significantly reduced.

Advantageously said needle axially divides the free space, whereby the processing material entering the free space is lubricated even more. Also the leakage of processing material to the outside becomes even less, commensurately increasing the sealing effectiveness.

In one advantageous embodiment of the present invention, at least one guide bush end zone is situated at least partly in the flow duct and is fitted with or subtends a contact surface for the flowable processing material. In this manner a portion of the guide bush always makes direct contact with the flowable processing material which, at every injection step, applies pressure on the guide bush. As a result, while overcoming the slight play of displacement, the contact surface is forced in sealing manner against the valve needle, whereby, during the high pressure stage, processing material no longer can leak out from the injection molding apparatus. The valve needle simultaneously is kept affixed by the guide bush in its central configuration and as a result, during the injection molding stage, the needle is prevented from any deviating motion. Once the injection molding pressure drops, the guide bush releases the needle which then may be immediately moved into the closed position.

Advantageously the contact surface is constituted by the end zone's, or tip's outer surface. As a result the guide bush's end zone is omnidirectionally immersed in flowable processing material moving past it. Said material therefore is able to act uniformly on the guide bush respectively the contact surface, hence the portion entering the flow region is uniformly pressed against the full periphery of the valve needle. This needle is sealed omnidirectionally and its position is centered. This effect is supported by the end zone being fitted with a cylindrical inner surface running coaxially with the valve needle. Accordingly this inner surface not only subtends a sealing area between the needle and the guide bush, but it also acts as a needle centering element.

Another important embodiment of the present invention provides that the guide bush be configured in the manifold plate. However the guide bush may be alternatively or additionally fitted into the needle valve nozzle. In any case the guide bush shall be preferably configured in the manifold plate and/or in the needle valve nozzle, the guide bush being affixable in the recess.

To prevent processing material from leaking from the mold through the recess, the guide bush is sealed within said recess by at least one surface perpendicularly to the longitudinal axis, said surface preferably constituting the recess' base.

Fitting the guide bush with a flange configured centrally in said recess is advantageous for its handling and affixation. The flange subtends a neck portion supporting or constituting the end zone entering the flow duct.

Further features, particulars and advantages of the present invention are defined in the appended claims and in the description below of illustrative embodiment modes shown in the drawings.

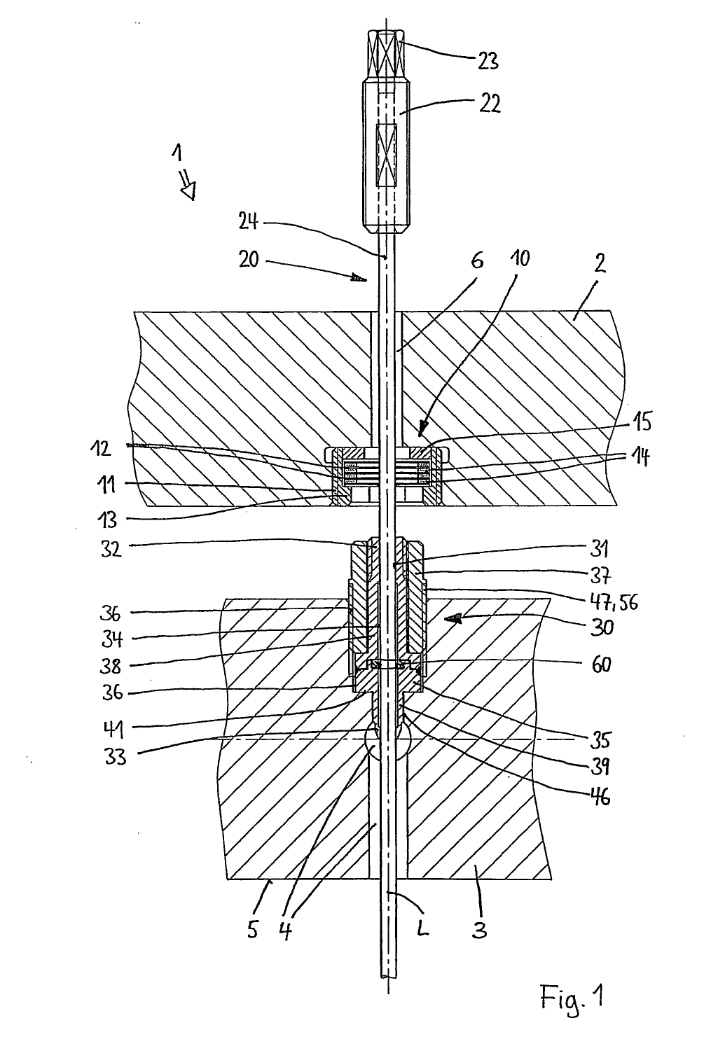

FIG. 1 shows part of a mold injection system comprising a sealing system for a valve needle, shown partly in section, and

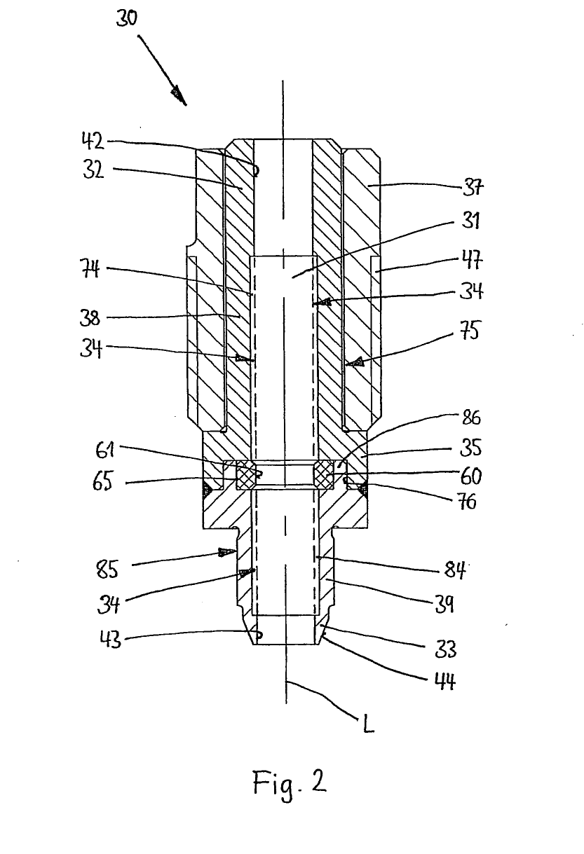

FIG. 2 is a separate cross-sectional view of the sealing system of FIG. 1.

The injection molding apparatus denoted overall by 1 in FIG. 1 is used to manufacture molded parts made of a flowable processing material such as a plastic melt. Said apparatus comprises a clamping plate 2 and parallel thereto a manifold plate 3 containing a system of flow ducts 4. Each duct issues into an omitted needle valve nozzle mounted to the underside 5 of the manifold plate 3.

Each needle valve nozzle further comprises a preferably externally heated nozzle body (also omitted) fitted inside of it with a processing material feed tube concentric with the longitudinal axis L to constitute an extension of the flow duct 4. Said duct terminates into nozzle mouth constituting a terminal nozzle aperture by means of which the processing material is moved through a sprue into a separable mold insert (also omitted).

A valve needle 20 is used to open and close the sprue aperture preferably subtended in the mold insert in longitudinally displaceable manner and traverses the flow duct 4 in the manifold plate 3, being displaceable by an omitted mechanical, electrical, pneumatic or hydraulic drive into a closed or open position. In its closed position the valve needle 20 engages—by an omitted, terminal sealing element—through the nozzle outlet aperture the sprue aperture which it seals.

At the mold side, the valve needle 20 is connected by the manifold plate 3 and the clamping plate 2 to the drive, the needle 20 terminally being fitted with an adapter 22 comprising a cross-sectionally polygonal terminal element 23. This terminal element is used for instance to connect to an omitted mold, to assemble the needle and to adjust it in length. Using an omitted locknut, the needle can be fixed in place irrotationally.

A feedthrough borehole 6 having an inside diameter larger than the outside diameter of the valve needle 20 is fitted into the clamping plate 2 to pass said valve needle 20.

A cleansing device 10 for the valve needle 20 is configured in the clamping plate 2. This cleansing device 10 comprises a housing 11 having a substantially cylindrical wall and a terminal, radially inward flanged rim 13. This flanged rim supports several planar cleansing elements 12 which at their edges are kept equidistant from each other by annular spacers 14. The planar cleansing elements 12 and the intermediate spacers 14 are secured in place within the cleansing device 10 by a securing ring 12 preferably screwed into the housing 11.

Each cleansing element 12 is centrally fitted with an aperture passing the valve needle 20. The inside diameter of said aperture is selected in a manner that its edge-subtended aperture makes contact frictionally and in geometrically locking manner with the outer surface 24 of the valve needle 20. Residues of processing material—for instance exuding from the guide bush 30—adhering to the outer periphery 24 of the valve needle 20 are always reliably seized and removed by the edges of the cleansing elements 12 matching the needle contour shape, in other words, the valve needle 20 passing through the cleansing device 10 respectively through the cleansing elements 12, is cleansed and thereby kept clean during the operation of the injection molding apparatus 1 at each reciprocating motion.

The needle seal configured in the manifold plate 3 is a guide bush 30 having a central feedthrough borehole 31 of which the inside diameter in the end zones 32, 33 of the bush 30 matches the outside diameter of the valve needle 20 except for a slight play of displacement. Accordingly said needle is centrally guided and supported within the bush 30.

An axially cylindrical free space 34 is subtended between the end respectively guide zones 32, 33 and exhibits an inside diameter slightly exceeding the outside diameter of the valve needle 20. Said free space receives a slight quantity of flowable processing material from the flow duct 4 during injection molding operation, thereby sealing the valve needle 20 from the flow duct 4 and the mold surroundings. At the same time the flowable processing material within the free space 34 acts as a lubricant reducing the friction between the valve needle 20 and the guide bush 30. Like the feedthrough borehole 6 in the clamping plate 2, said guide bush is configured coaxially with the valve needle 20 respectively its longitudinal axis L.

The guide bush 30 is fitted with a widened flange 35 centrally configured in a recess 36 in the manifold plate 3. Above the flange 35, the bush 30 comprises—in the direction of the clamping plate 2—a main part 38 of smaller outside diameter, which terminally constitutes the (upper) guide zone 32. This guide zone by its cylindrical inside surface 42 encloses the valve needle 20 except for a slight play of displacement. At the same time the guide zone 32 bounds the cylindrical free space 34 in the upward direction to prevent the processing material received in said free space from moving outward.

The main part 38 is coaxially enclosed by a screw bush 37. This bush is fitted with an external thread 47 engaging a matching inside thread 56 of the recess 36. Rotation of the screw bush 57 into the recess 36 and hence into the manifold plate 3 affixes the bush 30 in the mold by means of the flange 35. The base 41 of the recess 36 and the underside (not elucidated further) of the flange 35 in this process are superposed in geometrically locking manner, as a result of which the guide bush 30 is affixed not only in the manifold plate 3 but also simultaneously is sealed by a surface perpendicularly to the longitudinal axis L.

Underneath the flange 35, the bush 30, as seen in the direction of the needle valve nozzle, comprises a neck portion 39 of which the outside diameter also is smaller than the outside diameter of the flange 35. The lower end of the neck portion 39 constitutes the (lower) guide zone 33 which by its cylindrical inside surface 43 encloses the valve needle 20 down to a slight play of motion and correspondingly bounds downward the cylindrical free space 34. The wall thickness of the end respectively the guide zone 33 preferably is less than the wall thickness of the neck portion 39. Moreover the outer surface 44 of the end respectively guide zone 33 subtends an oblique surface 44, preferably a conical surface, as a result of which the wall thickness of the end respectively guide zone 33 tapers further toward the valve needle nozzle.

A feedthrough borehole 46 is fitted into the manifold plate 3 between the clearance 36 and the flow duct 4 to receive the neck portion 39, the inside diameter of said borehole substantially corresponding to the outside diameter. The neck portion 39 extends as far as into the flow duct 3, the end zone 33 by means of its inner surface 43 enclosing the valve needle 20 and its conical surface 44 entering—radially to and concentric with the longitudinal axis L—the flow duct 4 (FIG. 1). The guide zone 33 of the valve needle 20 in this manner is fully immersed in the flow of the processing material, the oblique respectively conical surface 44 constituting a contact surface which—just as the valve needle 20—is omnidirectionally immersed in the touching flow of processing material.

Operation of the valve seal means respectively the guide bush 30 substantially is based on the elastically deforming wall of the end zone 33 in the flow duct 4.

When the valve needle 20 is opened, it initially slides freely within the guide bush 30 from the closed position into the open one, the zone 32 and the end zone 33 sliding with little play of displacement along the outer surface 24 of the needle 20. Once this needle has reached its final respectively open position, the injection pressure is raised, that is, the melt to be processed is forced at high pressure through the melt duct 4 into the mold cavity. In this case the flowable processing material flows omnidirectionally and uniformly past the valve needle 20 and the end zone 33, said end zone 33 on account of its relatively thin wall and its elasticity being radially compressed. The cylindrical inner surface 43 comes to rest like a closing or valve element in geometrically hugging and sealing manner against the outer surface 24 of the valve needle 20, as a result of which—during injection—processing material from the flow duct 4 no longer can penetrate the free space 34 of the guide bush 30. The valve needle sealing effect of the present invention is substantially improved over that of the state of the art because—at the time of high pressurization in the flow duct 4—processing material now is precluded from leaking from the mold through the guide bush 30 to the outside. At the same time, the needle 20 is affixed in its concentric position relative to the longitudinal axis L. Furthermore the flowing processing material around the needle no longer is able to deflect said needle out of its centered position, this feature being advantageous for the flow conditions in the flow duct 4.

After the injection cycle has been completed, the pressure in the flow duct 4 is lowered. The end zone 33 resiliently resumes its initial shape and the inner surface 43 of the end zone 33 detaches off the outer surface 24 of the valve needle 20. Said needle then can be freely displaced into its closed position,

The wall thickness of the preferably steel end zone 33 is selected in a manner to be elastically deforming and so that the slight play of displacement between the valve needle 20 and the inside surface 43 can be overcome by the processing material pressure, as a result of which, during the high pressure stage in the mold, the needle 20 is stopped centrally and processing material cannot leak. Nevertheless the said needle 20 is guided accurately in gliding manner between the individual pressure cycles within the mutually spaced end zones 32, 33.

As shown in more detail in FIG. 2, a separate annulus 60 is used inside the bush 30 and is seated in a tight fit in a cylindrical recess 65 in the flange 35 while geometrically locking by its inside surface 61 to the outside surface 24 of the valve needle 20.

The inside diameter of the annulus 60 corresponds down to a slight play of displacement to the outside diameter of the needle 20, as a result of which said needle is additionally guided and supported within the bush 30. The annulus 60 simultaneously acts as an additional sealing element dividing the cylindrical free space 34 into two zones 74, 84. The upper zone 74 is bounded by the annulus 60 and the upper end zone 32 of the bush 30, the lower zone 84 being enclosed between the annulus 60 and the end zone 33 of the bush 30. As a result processing material entering the free space 34 is hardly able to leak out. Moreover, the three-point support design effectively precludes bending the valve needle 20 within said free space, offering advantageous operation of the valve needle nozzle.

The bush 30 is split in two in the zone of the flange 35 perpendicularly to the longitudinal axis L for the purpose of receiving the annulus 60. An upper part 75 constitutes the flange 35 and the main part 38 of the bush 30. The lower part 85 complements the flange 35 and constitutes the neck portion 39 having the annular-conical tip

The clearance 65 is situated in the lower bush part 85 which at the same time is also fitted with an engaging protrusion 86. Said protrusion engages in frictional and/or geometrically locking manner a corresponding recess 86 in the upper part 75, as a result of which the two parts 75, 85 can be connected to each other. In the embodiment mode of FIG. 2, the bush parts 75, 85 are peripherally welded to each other. However the parts 75, 85 may be pressed into one another or be firmly connected to each other using snap-in elements. Preferably the annulus 60 is metallic or a high-grade plastic such as Vespel.

The present invention is not restricted to the above described embodiment modes, but on the contrary it may be modified in many ways. Illustratively the guide bush 30 is not mandatorily configured in the manifold plate 3. Instead it may also be mounted in the valve needle nozzle. The wall thickness of the end respectively guide zone 33 need not mandatorily be less than that of the neck portion 39. They may be approximately equal. What is important however is that the end zone 33 immersed in the flowable processing material flowing around it shall deform enough during said high pressure stage so that its inner surface 43 shall rest in sealing manner against the outer surface 24 of the valve needle 20.

The contact surface 44 of the end zone 33 may be conical, though also convex or concave, such alternatives also allowing simple and accurate manufacture. This topography advantageously affects the pressure distribution.

The guide bush 30 may be affixed in the mold 1 not by the above discussed screw 37 but instead by an omitted flanged ring affixed by screws to the manifold plate 3 or to the valve needle nozzle. The important feature is that the guide bush 30 be sealed by at least one surface 41 perpendicularly to the longitudinal axis L within the recess 36.

The annulus 60 need not mandatorily be configured in the region of the flange 35. Instead it might be situated also in the main part 38 or in the neck part 39 of the bush 30. Again, several annuli 60 may be configured in mutual superposition, such a feature further enhancing sealing and guidance.

All features and advantages implicit or explicit in the claims, the specification and the drawing of the invention, inclusive design details, spatial configurations and process steps, whether considered per se or in arbitrary combinations, may be construed being inventive.

LIST OF REFERENCES

| L | longitudinal axis |
|---|---|
| 1 | injection molding apparatus |
| 2 | clamping plate |
| 3 | manifold plate |
| 4 | flow duct |
| 5 | lower side |
| 6 | feedthrough borehole |
| 10 | cleansing device |
| 12 | cleansing element |
| 11 | housing |
| 14 | spacer |
| 15 | securing annulus |
| 20 | valve needle |
| 22 | adapter |
| 23 | end zone |
| 24 | outer circumference/surface |
| 30 | guide bush |
| 31 | feedthrough borehole |
| 32 | end/guide zone |
| 33 | end/guide zone |
| 34 | free space |
| 35 | free space |
| 36 | recess |
| 37 | screw bush |
| 38 | main part |
| 39 | neck portion |
| 41 | base |
| 42 | inner surface |
| 43 | inner surface |
| 44 | contact surface/outside surface/ |
| | oblique surface |
| 46 | feedthrough borehole |
| 47 | outer thread |
| 56 | inner thread |
| 60 | annulus |
| 61 | inner surface |
| 65 | recess |
| 74 | upper zone |
| 75 | upper part |
| 76 | offset |
| 84 | lower zone |
| 85 | lower part |
| 86 | recess |

1. Injection molding apparatus (1) comprising a manifold plate (3) fitted with at least one flow duct (4) for a flowable processing material, comprising further at least one needle valve nozzle by means of which the flowable processing material—with an extended flow duct (4)—can be fed to a separable mold insert, further at least one valve needle (20) traversing the flow duct (4) at least segment-wise in longitudinally displaceable manner and being driven by a drive into an open and a closed position, and further a guide bush (30) to pass and guide the valve needle (20), characterized in that an annulus (60) is fitted into the guide bush (30) and encloses the valve needle (20) in geometrically locking manner.

2. Injection molding apparatus as claimed in claim 1, characterized in that the annulus (60) comprises a cylindrical inside surface (61) coaxial with the valve needle (20).

3. Injection molding apparatus as claimed in claim 1, characterized in that the annulus (60) is configured perpendicularly to the longitudinal axis (L) of the valve needle (20).

4. Injection molding apparatus as claimed in claim 1, characterized in that the annulus (60) is contained at a tight fit in the bush (30).

5. Injection molding apparatus as claimed in claim 1, characterized in that the annulus (60) is made of an elastic steel or an elastic, high-temperature resistant plastic.

6. Injection molding apparatus as claimed in claim 1, characterized in that the guide bush (30) is in two parts.

7. Injection molding apparatus as claimed in claim 5, characterized in that the guide bush (30) comprises two parts (75, 85) of which at least one receives the annulus (60).

8. Injection molding apparatus as claimed in claim 1, characterized in that it comprises at least two annuli (60).

9. Injection molding apparatus as claimed in claim 1, characterized in that the guide bush (30) comprises at least two zones (32, 33) axially away from the annulus (60), said zones having inside circumferential surfaces (42, 43) coaxial with the valve needle (20).

10. Injection molding apparatus as claimed in claim 8, characterized in that the zones (32, 33) constitute end zones of the guide bush (30).

11. Injection molding as claimed in claim 1, characterized in that the annulus (60) and the end zones (32, 33) enclose the valve needle (20) with the least possible play of displacement.

12. Injection molding apparatus as claimed in claim 1, characterized in that a free space (34) is subtended between the end zones (32, 33) and that its inside diameter is slightly larger than the outside diameter of the valve needle (20).

13. Injection molding apparatus as claimed in claim 11, characterized in that the free space (34) is axially divided by the annulus (60).

14. Injection molding apparatus as claimed in claim 1, characterized in that at least one end zone (33) of the guide bush (30) is configured at least in part in the flow duct (4) and is fitted with or constitutes a contact surface (44) for the flowable processing material.

15. Injection molding apparatus as claimed in claim 13, characterized in that the contact surface (44) is constituted by the outer surface of the end zone (33).

16. Injection molding apparatus as claimed in claim 1, characterized in that the guide bush (30) is configured in the manifold plate (3) or in the valve needle nozzle.

17. Injection molding apparatus as claimed in claim 15, characterized in that the guide bush (30) is seated in a recess (36) in the manifold plate (3) and/or in the needle valve nozzle.

18. Injection molding apparatus as claimed in claim 16, characterized in that the guide bush (30) can be affixed in the recess (36).

19. Injection molding apparatus as claimed in claim 16, characterized in that the guide bush (30) is sealed within the recess (36) by means of at least one surface (41) perpendicular to the longitudinal axis (L).

20. Injection molding apparatus as claimed in claim 18, characterized in that the surface (41) is the base of the recess (36).

21. Injection molding apparatus as claimed in claim 16 characterized in that the guide bush (30) comprises a flange (35) centrally seated in the recess (36).

22. Injection molding apparatus as claimed in claim 16, characterized in that the guide bush (30) comprises a neck portion (39) terminally supporting or constituting the zone (33).
